(19) United States
(12) Patent Application Publication
(10) Pub. No.: US 2024/0016122 A1
(43) Pub. Date: Jan. 18, 2024

(54) PET TOY

(71) Applicant: Richard A. Carmody, III, Ringgold, GA (US)

(72) Inventor: Richard A. Carmody, III, Ringgold, GA (US)

(21) Appl. No.: 18/221,457

(22) Filed: Jul. 13, 2023

Related U.S. Application Data
(60) Provisional application No. 63/389,067, filed on Jul. 14, 2022.

(51) Int. Cl. A01K 15/02

(52) U.S. Cl. CPC A01K 15/025

(57) ABSTRACT

A pet toy has a first exercise path disposed proximate to a perimeter of the toy which directs a target near the perimeter to potentially be chased by a pet. The pet toy may have a plurality of exercise paths, potentially parallel to one another providing a plurality of target options for a pet to chase. The targets are driven by one or more motors, which may be provided with electricity from a battery/solar cell combination. Tunnels may pass through a base under the first exercise path which can meet at a central vertical passage to then extend outwardly horizontally through horizontal passages to a top of the pet toy.

### CLAIM OF PRIORITY

This application claims the benefit of U.S. Provisional Application No. 63/389,067 filed Jul. 14, 2022, which is incorporated herein by reference in its entirety.

### FIELD OF THE INVENTION

The present invention relates to pet toys and more particularly to a pet toy calculated to provide entertainment and possibly relaxation to various pets.

### BACKGROUND OF THE INVENTION

Many pet toys exist in the marketplace. Nevertheless, an improved pet toy is believed to be desirable.

Specifically, there is believed to be a need to provide active and interactive components in a pet toy for at least some embodiments.

### SUMMARY OF THE INVENTION

It is an object of many embodiments of the present invention to provide a pet toy having active and interactive components.

It is an object of many embodiments of the invention to provide an improved pet toy.

Accordingly, a pet toy is provided with a first exercise path preferably defined by a series of discs which drive a rope with a flag or other object connected thereto. At least one of the discs is driven so that as the drive disc rotates, the rope rotates thereby driving the flag about an exercise path. The first exercise path may be at a perimeter of the toy, and a second exercise path may be defined be a second series of discs, possibly above the first series which could be driven by a second drive disc(s) possibly in an opposite direction as the first exercise path so that the pet may have trouble deciding which direction to pursue about the toy. The first and second exercise paths may be circular or oval for at least some embodiments. Other exercise path shapes may be provided with other embodiments. Some embodiments may have more than two exercise paths, such as four exercise paths.

A camera or cameras may be located about the toy to record play of the pet. The size of the toy may be selected based on the size of an animal to play with the toy. Interior or exterior versions may be provided. An interior unit may have suction cups on a lower surface of a base to assist in securing the toy to a particular floor. An exterior unit may have a base with securing locations for a stake to pass through to secure to the ground.

An app and/or website may cooperate with the pet toy for an owner to monitor their pet playing with the toy. Video footage from the camera could be downloaded remotely for viewing. Ads may display on the app/website to generate another source of revenue possibly in addition to subscription fees paid by the owner.

The app and/or website may monitor caloric burn of the pet by monitoring the pet as it chases the flag/object, calculating a calorie burn based on at least some of speed of the pet, time at speed and/or distance traveled. The caloric burn of the pet could be combined data to assist in determining an overall health of the pet. If provided as an app, a notification could be provided to the owner if the algorithms of the app/website detect an abnormality with the pet, such as if the pet stopped suddenly, such as due to heat stroke, or if the pet stumbled and possibly hurt a paw and began to limp. A collar could be attached to the pet which could communicate with the app/website to assist in providing data such as heart rate, distance traveled, speed, etc. to assist in determining the health and/or activity of the pet.

The pet toy may have a speaker either for direct interaction with the pet by an owner remotely or with recorded audio (either of the owner, music, etc.). Veterinary service may be provided for emergency, along with notification to the yet, if so elected or otherwise, by the owner, in the event of an injury, heat stroke, etc.

Power may be provided from a home outlet and/or from solar energy, such as by external solar cell(s) which may be south easternly facing for at least some embodiments. An internal battery may receive and store power for future use. Power may be useful for the motor(s), camera(s), self-propelled ball(s), charging station, speaker(s), and possibly a treat distribution device.

Some embodiments may provide a self-propelled or driven ball that moves about the exercise path(s). A hollow donut shaped tube, possibly plastic, may encircle an axle. A coil of copper wire, preferably continuous, may be wrapped about the tube. A magnetic ball may revolve inside the tube as the ball rotates. When the magnetic ball passes through the coiled copper, electromagnetic energy may be generated. This energy may be directed towards an internal battery to store energy. As the ball consumes energy to rotate, a portion of expended energy may be captured by the magnetic ball/coil arrangement to assist in prolonging play between charges. A charging station may be provided with the toy to recharge self-propelled ball, somewhat similar to a robotic vacuum returning to a charging station.

Still other embodiments may provide a laser pointer directed about an exercise path. The laser pointer may be movable relative to a path of the carriage on the exercise path so as to provide additional movement as the carriage proceeds about the exercise path so as to potentially speed up or slow down as the carriage proceeds about the exercise path, or proceed in eccentric paths depending on the location of the laser pointer relative to the carriage.

The pet toy may be located on grass, artificial turf and/or recycled rubber tire tracks to assist in reducing impact to the joints of a pet playing with the pet toy.

### BRIEF DESCRIPTION OF THE DRAWINGS

The particular features and advantages of the invention as well as other objects will become apparent from the following description taken in connection with the accompanying drawings in which:

FIG. 1 is a front plan view of a first preferred embodiment with detail A shown in FIG. 3;

FIG. 2 is a cross sectional view taken along the line D-D of FIG. 1;

FIG. 3 is a side perspective view showing a second preferred embodiment of the present invention including detail A which would also be present in the first preferred embodiment;

FIG. 4 is a top plan view of a third preferred embodiment similar to the second preferred embodiment of FIG. 3 in that cross section E-E would be identical in both;

FIG. 5 is a cross section taken along the line B-B in FIG. 3;

FIG. 6 is a cross sectional view taken along the line C-C in FIG. 3;

FIG. 7 is a top plan view of a fourth alternatively preferred embodiment; and

FIG. 8 is a side plan view of the embodiment of FIG. 7 showing detail A which would be detail A from FIG. 3.

### DETAILED DESCRIPTION OF THE PREFERRED EMBODIMENT

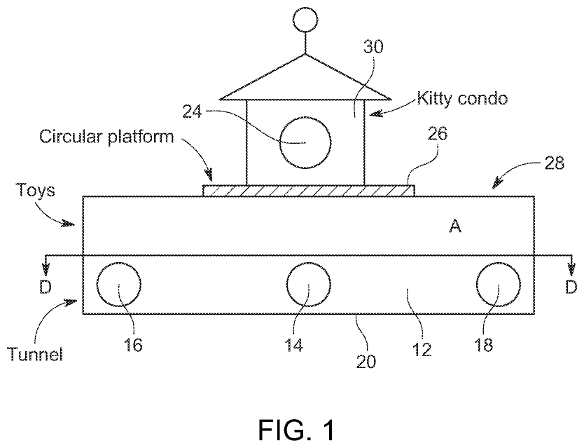

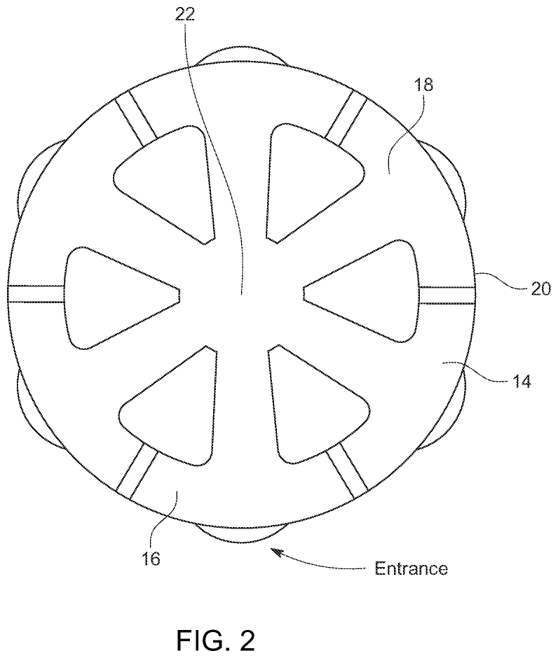

The figures show different embodiments of the invention which may be portions of detail A shown in the various figures. FIG. 1 has detail A supported by a base 12 which has a first, second and third tunnel 14,16,18 extending from an exterior surface 20 of the base 12 inwardly, preferably at least some of which, if not all, are in communication with a vertically extending central passage 22 which extend through detail A to above detail A to a horizontal passage 24 which leads to a platform 26 and/or an upper surface 28 of detail A of the pet toy 10. There may be multiple horizontally extending passages 24, possibly bisecting cap 30 on top or an upper surface 28 of at least portions shown in detail A. The first, second and third tunnels may or may not bisect the base 12 and preferably at least some of the first second and third tunnels 14,16,18 are non-linearly disposed relative to one another.

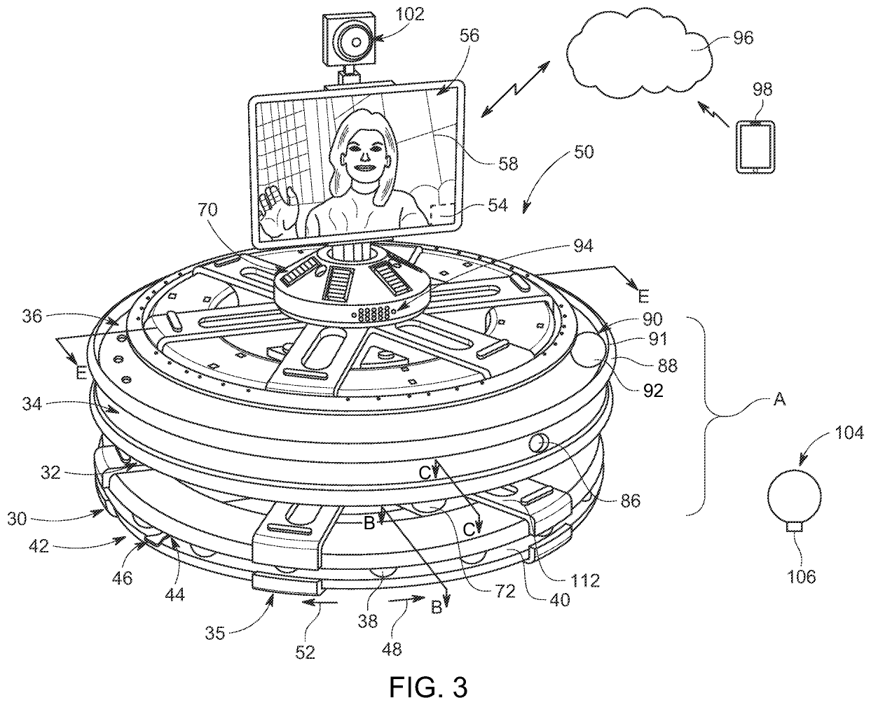

FIG. 3 shows detail A the best of all of the figures. A first track 30 is supported by the base 12 or 35 in FIG. 3. The first track 30 has a plurality of rotating discs 38, which contact a line 40 in contact therewith so that the discs may act like bearings so that the line 40 rotates proximate to the perimeter of the first track 30, the base 12 and/or the pet toy 50. The line 40 may be a belt, rope, cable, or other appropriate material. Attached to the line 40 is a target 42 which has an extension 44 and a flag 46 and/or another object connected thereto. The line 40 provides a first exercise path with the first target 42 being directed in motion along the first track 30 in at least a first direction 48. The first target 42 may also be directed in the second direction 52 for at least some embodiments, possibly those having a processor 54, possibly as a portion of a computing device 56 having a display 58. Other processors 54 may be provided with other embodiments to accommodate various levels of sophistication.

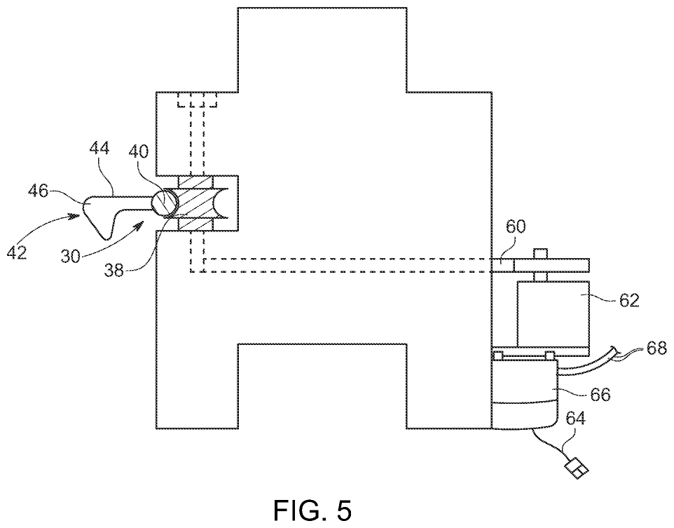

FIG. 5 shows cross section B-B from FIG. 3 with one of the plurality of rotating discs 38 driven, possibly by belt 60 or otherwise by motor 62. Motor may receive power from an external electrical source, such as via cord 64 or a battery 66 which may be connected to cord 64 or to solar panels 70 via wires 68 as is shown in the Figures. FIG. 5 shows a stackable arrangement or various first tracks 30 if so desired. The motor 62 moves the first target 42 about the first exercise path with the first target 42 being restrained to the first track 30 and restricted to move relative to the first exercise path and the first track 30 (shown as the line 40 for this embodiment).

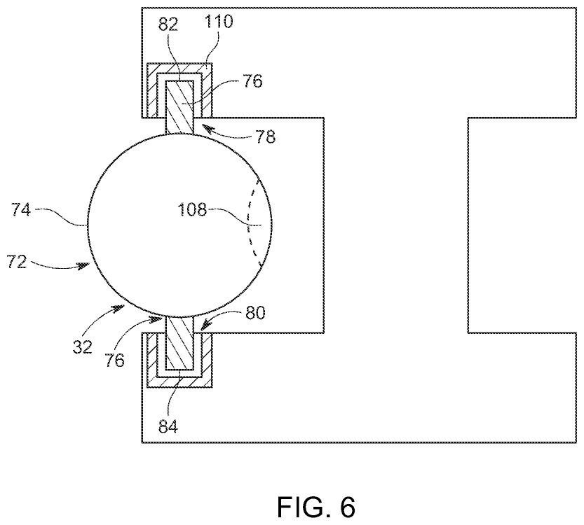

FIG. 6 shows cross section C-C of FIG. 3 as a second track 32 which is also continuous. Second track directs motion of a second target 72 in at least the second direction 52, if not also the first direction 48 as directed by the processor 54 or otherwise relative to the second exercise path which may be dictated by the second track 32. Note that the second direction 52 is opposite to the first direction 48.

The path of the second target 72 is proximate to an exterior perimeter of the second track 32, whether that be slightly internal to the exterior perimeter of the pet toy 50 at the second track 32 as illustrated, at the perimeter like a portion of the extension 44, or slightly external to the perimeter like the flag 46.

The second track 32 is shown as being parallel to the first track 30 (as well as the third and fourth tracks 34,36 if utilized). The tracks 30-36 are also preferably horizontally oriented for many embodiments, as illustrated.

The second target 72 may be a ball 74 possibly supported by an axle 76 extending through the ball 74. The second track 32 may have opposing slots 78,80 which receive opposite ends 82,84 of the axle 76. The axle 76 is shown in a vertical orientation. Other orientations may be provided with other second tracks 32 or other tracks 30, 34-36.

A third track 34 may be provided similar to or dissimilar from second track 32 with one or more third target(s) 86. The third track directions motion of the third target 86 in at least a first direction, if not the first and/or second direction 48,52. The third track 34 may define a third exercise path proximate to the exterior perimeter of the pet toy 50 or the third track 34.

A fourth track 36 may have a fourth target 88 which may provide one or more lasers 90,91 such as from a carriage 92 which could be round or other shape to travel about a fourth exercise path relative to the fourth track 36. Multiple lasers 90,91 could be provided on a carriage or carriages 92 and various targets 42,72,86,88 could provide lasers. Multiple targets 42,72,86,88 could be provided on each of the respective tracks 30,32,34,36. The fourth track 36 is shown above the third track 34 which is above the second track 32 and above the first track 30. Paths of lasers 90 may be a concentric path about the pet toy 50 or possibly eccentric relative to the respective exercise path, such as fourth track 36 as would be understood by those of ordinary skill in the art. Lasers 90,91 may be a type 1 or other laser type which is not harmful when shined in the eye of a pet or person for at least some embodiments.

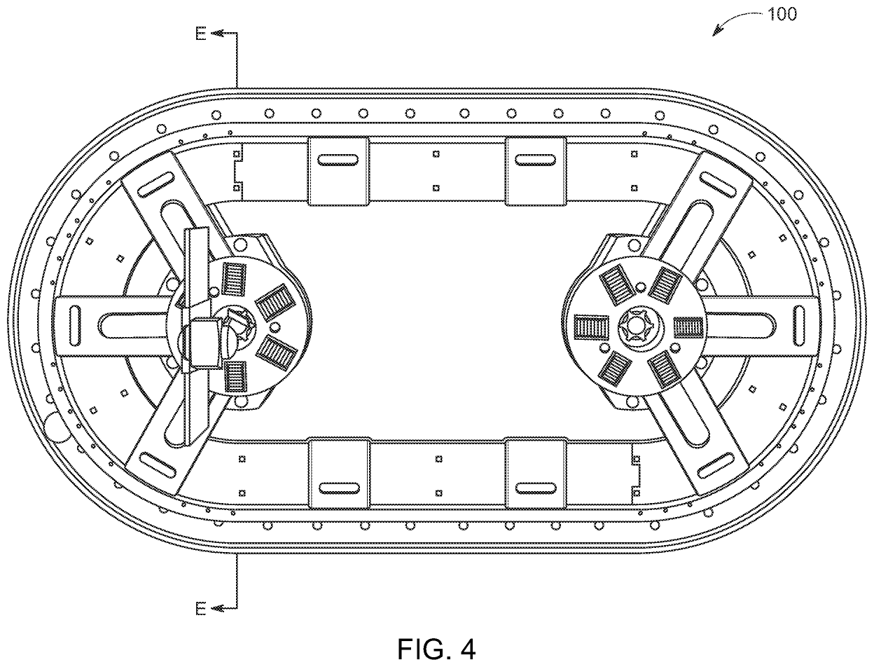

The first through fourth tracks 30-36 in FIG. 3 are round. Similar tracks in FIG. 4 would be oval based on the perimeter of the pet toy 100, however the cross section of E-E in FIGS. 4 and 3 are identical in the illustrated embodiments.

Speaker 94 may be provided to play recorded audio and/or assist in communication with a pet, such as if the processor 54 is in communication such as wirelessly through various means and/or the internet 96 to a remote user having a computing device 98 (like a computer, tablet, smartphone, etc.) through an app and/or website, hereafter app/website so that the owner/user may watch their pet in action such as through the camera 102 possibly while providing an image to the pet at display 58 and audio at speaker 94. The camera 102 and speaker 94 are connected to the pet toy 50.

Depending upon the sophistication of the processor 54 and/or app/website, and possibly a collar 104 having a processor 106 like a smart fitness bracelet which could process Global Positioning Service (GPS) data, heart rate, etc., the exercise activity of a pet may be monitored and reported remotely to the user having the computing device 98. Ads may be displayed on the app/website, to assist in generating revenue in addition to subscription fees for the remote service to the computing device 98 which could include video of the pet in play as well as exercise data relative to the pet such as heart rate, speed, an indication of activity level/calories expended based on distance traveled, speed, time at speed, etc. The camera 102 and/or collar 104 data may be used to detect emergencies such as heat stroke, injury to a leg/paw, etc. to be reported to the user of the computing device 98 or possibly directly to a veterinarian.

Second, third or fourth tracks 30,32,34 may have targets 72,86,88 that are self-propelled if they are not driven by a separate motor like the first target 42. As shown in FIG. 6, the ball 74 may be supported on an axle 76. A hollow shaped donut tube forming slots 78,80 may encircle the axle 76. A magnet 108 may rotate around inside the tube. As the ball 74 rotates relative to a coil 110, such as a continuous copper wire or other structure, electromagnetic energy may be generated. This energy may be directed to the battery 66 for later usage and returned to assist in driving the target 72 about the track 30, etc. Charging stations 112 may be provided to recharge targets 72,86,88, if so configured

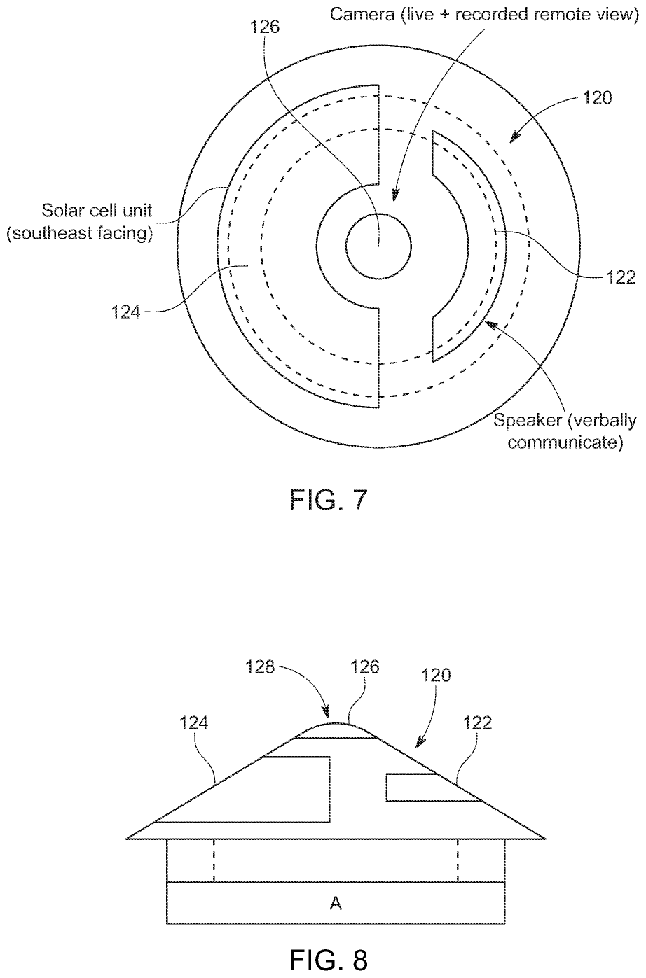

FIG. 7 shows an alternative embodiment top 120 having a speaker 122 and at least one solar panel 124, which could be southeastern facing in an effort to maximize conversion of sunlight to electrical energy. A camera 126 is located at a pinnacle 128 of the top 120. Other locations could be employed with other embodiments.

FIG. 8 shows the top 120 connected to detail A, such as shown in FIG. 3. Other configurations of tops could be used with other embodiments.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed is:

1. A pet toy comprising:
a base supporting a continuous first track, said first track directing motion of a first target in at least a first direction relative to a first exercise path proximate to an exterior perimeter of the first track, and a motor, said motor moving the first target about the first exercise path, said first target restrained to the first track and restricted to move relative to the first exercise path.

2. The pet toy of claim 1 further comprising a plurality of rotating discs disposed about the perimeter of the pet toy with a line contacting the rotating discs to define the first track.

3. The pet toy of claim 2 further comprising an extension connecting the first target to the line.

4. The pet toy of claim 1 further comprising a continuous second track, said second track directing motion of a second target in at least a first direction relative to a second exercise path proximate to an exterior perimeter of the second track.

5. The pet toy of claim 4 wherein the second exercise path is parallel to the first exercise path.

6. The pet toy of claim 5 wherein the first direction of the first target is oppositely directed relative to the first direction of the second target.

7. The pet toy of claim 5 wherein the first target has a flag and the second target has a ball.

8. The pet toy of claim 7 wherein the second track has opposing slots, and wherein the ball of the second target is supported on an axle extending through the ball into the opposing slots.

9. The pet toy of claim 8 wherein the axle is maintained in a vertical orientation.

10. The pet toy of claim 4 further comprising a continuous third track, said third track directing motion of a third target in at least a first direction relative to a third exercise path proximate to the exterior perimeter of the third track.

11. The pet toy of claim 10 wherein the third target has a laser on a carriage, and the third track is located above the second track and the first track.

12. The pet toy of claim 1 wherein the first track is one of a circle and an oval.

13. The pet toy of claim 1 further comprising a speaker, said speaker connected remotely to a computing device of an individual whereby the individual can speak into the computing device to be broadcast audibly at the speaker.

14. The pet toy of claim 1 further comprising a camera connected to the pet toy, said camera directing video feed remotely for viewing by an individual at a computing device.

15. The pet toy of claim 1 further comprising a battery and at least one solar panel on an exterior surface of the pet toy, said battery connected to the solar panel and said battery providing electricity to the motor.

16. The pet toy of claim 1 further comprising a first tunnel in the base extending from an exterior surface of the base internal to the base.

17. The pet toy of claim 16 further comprising a central vertically extending passage extending upwardly from the base internal to the first track and leading to a horizontally extending passage above the first track onto an upper surface of the pet toy, said first tunnel in communication with the central vertically extending passage.

18. The pet toy of claim 17 further comprising a second tunnel in the base extending from the exterior surface of the base internal to the base in communication with the central vertically extending passage.

19. The pet toy of claim 18 wherein the second tunnel is non-linearly disposed relative to the first tunnel.

20. The pet toy of claim 1 in combination with an app/website whereby the app/website tracks exercise activity of a pet in proximity to the pet toy and provides reports thereon.
